(19) United States
(12) Patent Application Publication
(10) Pub. No.: US 2026/0067444 A1
(43) Pub. Date: Mar. 5, 2026

(54) METHOD AND DEVICE FOR VIDEO SEE-THROUGH, STORAGE MEDIUM, AND PROGRAM PRODUCT

(71) Applicant: Beijing Zitiao Network Technology Co., Ltd., Beijing (CN)

(72) Inventors: Yuechuan ZHANG, Beijing (CN); Zhiyou WU, Beijing (CN); Sitong LI, Beijing (CN); Nongwei LEI, Beijing (CN)

(21) Appl. No.: 19/316,823

(22) Filed: Sep. 2, 2025

(30) Foreign Application Priority Data
Sep. 2, 2024 (CN) 202411224047.6

(51) Int. Cl. H04N 13/366; H04N 13/00; H04N 13/111; H04N 13/15; H04N 13/332

(52) U.S. Cl. CPC H04N 13/366; H04N 13/111; H04N 13/15; H04N 13/332; H04N 2013/0081

(57) ABSTRACT

Embodiments of the present disclosure provide a method and a device for Video See-Through (VST), a storage medium, and a program product. The method comprises: obtaining a first posture in a first Degree of Freedom mode; determining first depth information of a preset stereoscopic shape; and determining a first VST result according to the first depth information and the first posture.

### CROSS-REFERENCE TO RELATED APPLICATION(S)

The present disclosure claims the priority from the CN patent application No. 202411224047.6 entitled Method and device for video see-through, storage medium, and program product” filed with the China National Intellectual Property Administration (CNIPA) on Sep. 2, 2024, the contents of which are hereby incorporated by reference in their entirety.

### FIELD

Embodiments of the present disclosure relate to the field of Extended Reality (XR), and specifically, to a method and a device for Video See-Through (VST), a storage medium, and a program product.

### BACKGROUND

VST technology can provide interaction with the virtual world while maintaining the perception of the real world, which is very important for security, interaction and Mixed Reality (MR) applications.

### SUMMARY

Embodiments of the present disclosure provide a method, a device, a storage medium and a program product for VST.

In a first aspect of the present disclosure, embodiments of the present disclosure provide a method for VST. The method comprises:
obtaining a first posture in a first Degree of Freedom (DOF) mode;
determining first depth information of a preset stereoscopic shape;
determining a first VST result according to the first depth information and the first posture.

In a second aspect, embodiments of the present disclosure provide a device for VST, comprising:
an obtaining module for obtaining a first posture in a first DOF mode;
a depth module for determining first depth information of a preset stereoscopic shape;
a determining module for determining a first VST result according to the first depth information and the first posture.

In a third aspect, embodiments of the present disclosure provide an electronic device comprising a processor and a memory;
the memory stores computer-executed instructions;
the processor executes the computer-executed instructions stored in the memory, so that the at least one processor executes the method for VST as described in the first aspect and various possible designs of the first aspect.

In a fourth aspect, embodiments of the present disclosure provide a computer-readable storage medium, in which computer-executable instructions are stored, and when the computer-executable instructions are executed by a processor, the method for VST described in the first aspect and various possible designs of the first aspect is realized.

In a fifth aspect, embodiments of the present disclosure provide a computer program product, comprising a computer program, which, when executed by a processor, realizes the method for VST as described in the first aspect and various possible designs of the first aspect.

### BRIEF DESCRIPTION OF THE DRAWINGS

In order to explain the embodiments of the present disclosure or the subject matter in the prior art more clearly, the drawings needed in the depiction of the embodiments or the prior art would be briefly introduced below. Obviously, the drawings in the following depiction are some embodiments of the present disclosure, and other drawings can be obtained according to these drawings without inventive effort for those skilled in the art.

FIG. 1 illustrates a schematic diagram of an application scenario of a method for VST according to an embodiment of the present disclosure;

FIG. 2 illustrates a flowchart I of a method for VST according to an embodiment of the present disclosure;

FIG. 3 illustrates a flowchart II of a method for VST according to an embodiment of the present disclosure;

FIG. 4 illustrates a structural block diagram of a device for VST according to an embodiment of the present disclosure; and

FIG. 5 illustrates a structural diagram of hardware of an electronic device according to an embodiment of the present disclosure.

### DETAILED DESCRIPTION OF EMBODIMENTS

In order to make the purpose, subject matter and advantages of the embodiment of the disclosure more clear, the subject matter in the embodiment of the disclosure would be described clearly and completely with the attached drawings. Obviously, the described embodiment is a part of the embodiment of the disclosure, but not the whole embodiments. Based on the embodiments in this disclosure, all other embodiments obtained by those skilled in the art without inventive effort belong to the protection scope of this disclosure.

VST is a see-through technology implemented in an XR device, such as a Virtual Reality (VR) device, which allows users to see a real-time view of the real world through a display device, such as a head-mounted display device. This technology usually captures the external environment through a camera on a head-mounted display device, and combines a video image with the virtual content and displays it on the screen. The VST technology can provide interaction with the virtual world while maintaining the perception of the real world, which is very important for security, interaction and MR applications.

In related technologies, the XR device cannot support the VST display effect in some scenarios, and the user experience is poor.

In the related art, VST images are usually synthesized based on a 6 DOF posture provided by the display device. However, the above method is highly dependent on 6 DOF. When there is a problem with 6 DOF data, VST cannot be realized, resulting in low fluency for VST and poor user experience.

In order to solve the above technical problems, the inventors of this disclosure found that when the display device fails to obtain 6 DOF data, for example, only providing 3 DOF data, mainly fails to obtain depth information for further fusion, the display device can be provided with preset depth information, such as depth information of preset stereoscopic shape. As such, the obtained image of the environment can be fused with the depth information to realize VST display, thus improving the fluency for VST and user experience. Based on this, the embodiment of the present disclosure provides a method for VST.

Embodiments of the present disclosure provide a method, a device, a storage medium and a program product for VST to realize VST in more scenarios, improving VST fluency and user experience.

Embodiments of the present disclosure provide a method, a device, a storage medium and a program product for VST. The method comprises: obtaining a first posture in a first Degree of Freedom (DOF) mode; determining first depth information of a preset stereoscopic shape; determining a first VST result according to the first depth information and the first posture. According to the method for VST of the embodiments of the present disclosure, fixed depth information is obtained by constructing a preset stereoscopic shape, and then VST effect is realized based on the fixed depth information. As such, the VST effect can be realized under the condition that the depth information is not fully obtained or cannot be obtained, improving the smoothness of image display of a display device such as a head-mounted device and enhancing the user experience.

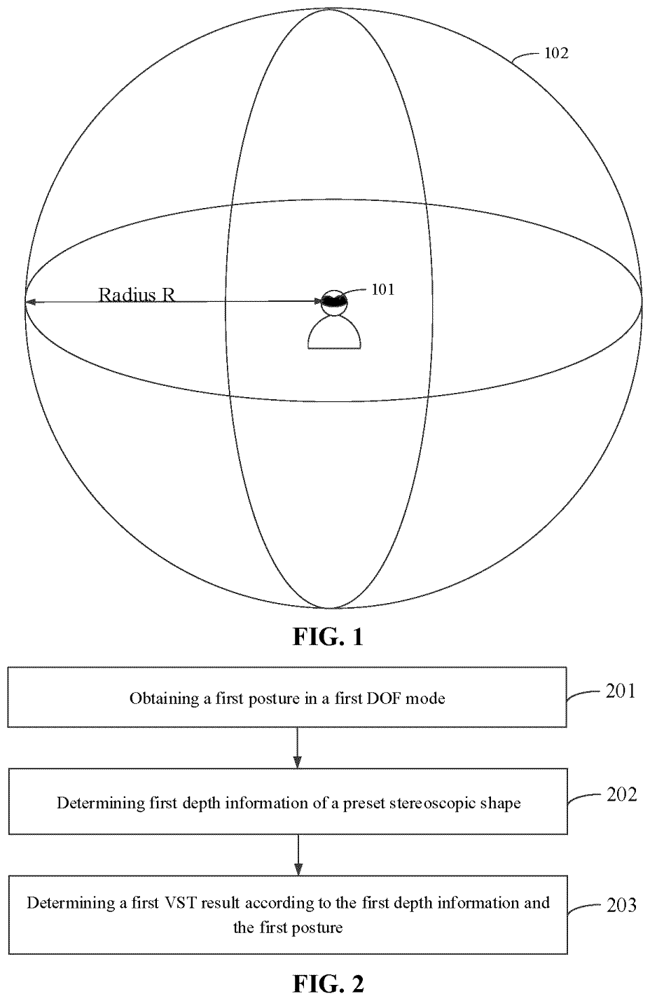

FIG. 1 illustrates a schematic diagram of an application scenario of a method for VST according to an embodiment of the present disclosure. As shown in FIG. 1, a user wears a display device 101. The display device 101 may be an XR device such as a VR device, an AR device and an MR device, and may be a head-mounted display device.

In the specific implementation process, the display device 101 can enter the first DOF mode (for example, a 3 DOF mode), obtain the first posture in the first DOF mode, determine the first depth information of a preset stereoscopic shape 102 (which can be a sphere with a radius r), and determine the first VST result according to the first depth information and the first posture. According to the method for VST of the embodiments of the present disclosure, fixed depth information is obtained by constructing a preset stereoscopic shape, and then VST effect is realized based on the fixed depth information. As such, the VST effect can be realized under the condition that the depth information is not fully obtained or cannot be obtained, improving the smoothness of image display of a display device such as a headset and enhancing the user experience.

It should be noted that the scenario schematic diagram shown in FIG. 1 is only an example, and the method for VST and scenario described in the embodiment of present application are for the purpose of more clearly explaining the subject matter of this embodiment of the present application, and do not constitute a limitation on the subject matter provided by this embodiment of the present application. Those skilled in the art would know that with the evolution of the system and the emergence of new business scenarios, the subject matter provided by this embodiment of the present application is also applicable to similar technical problems.

The subject matter of present application would be described in detail with specific examples. The following specific embodiments can be combined with each other, and the same or similar concepts or processes may not be repeated in some embodiments.

FIG. 2 illustrates a flowchart I of a method for VST according to an embodiment of the present disclosure. As shown in FIG. 2, the method for VST comprises:
201. Obtaining a first posture in a first DFO mode.

The execution subject of the embodiment of the present disclosure may be a display device, for example, the display device 101 shown in FIG. 1.

The first DOF mode can be a DOF mode with the number of DOF less than 6, for example, the 3 DOF mode. The first posture may include positions and poses, or only poses, determined according to the DOF. In the 3 DOF mode, although only the poses can be provided, and the positions cannot be provided, the method for VST provided by the embodiment of the present disclosure can provide the first depth information of the preset stereoscopic shape, and then the VST display in the 3 DOF mode can be realized based on the first depth information and the first posture, broadening the application scenarios for VST, improving the fluency for VST and the user experience.

In one embodiment of the present disclosure, the first DOF mode may be a mode of the display device or a mode to be switched to when a trigger condition is met. Specifically, obtaining the first posture in the DOF mode comprises: in response to quality of posture data obtained in a second DOF mode being lower than a preset standard, switching to the first DOF mode to obtain a first posture in the first DOF mode, wherein the number of DOF obtained in the first DOF mode is smaller than that obtained in the second DOF mode.

In one embodiment of the present disclosure, the quality of posture data obtained in the second DOF mode being lower than the preset standard comprises meeting at least one of the following: 1. light intensity of current environment being less than a first intensity or greater than a second intensity, wherein the first intensity is smaller than the second intensity; 2. a jitter value of the display device being greater than a preset jitter threshold; 3. an error of sensor data of the display device being greater than a first preset error value; 4. an error of image data obtained by a camera of the display device being greater than a second preset error value.

Illustratively, the second DOF mode being a 6 DOF mode is taken as an example. It can be determined that the 6 DOF quality is lower than the preset standard in the following cases:

The first case: the image obtaining is invalid-because the head-mounted device needs to locate the 6 DOF of the collected environmental image, when the camera is detected to be blocked or the collected image is identified as invalid, the 6 DOF quality may be lower than the preset standard.

The second case: the head-mounted device is too shaken—when the head-mounted device is too shaken, it is usually difficult to collect high-quality images or calculate the position and pose of the device, which may lead to the 6 DOF quality lower than the preset standard.

The third case: there are too few environmental feature points—because the head-mounted device needs to locate 6 DOF based on the feature points in the collected environmental image, when the user faces a solid color wall, a wallpaper with repeated patterns or a mirror, the 6 DOF quality may be lower than the preset standard.

The fourth case: the quality of environmental feature points is low—when the brightness of the collected image is too low, lower than the preset first brightness threshold, or the brightness of the collected image is too high, higher than the second brightness threshold, the image quality is poor. This may lead to the 6 DOF quality lower than the preset standard.

In the embodiment of the present disclosure, the trigger conditions for switching from the second DOF mode to the first DOF mode may also be that the depth sensor is unavailable and depth information cannot be obtained.
202. Determining first depth information of a preset stereoscopic shape.

In the embodiment of the present disclosure, the preset stereoscopic shape can be a centrosymmetric stereoscopic shape, such as a sphere, a cube, or a non-centrosymmetric stereoscopic shape, such as a cuboid, an ellipsoid, a vertebral body, etc. The preset stereoscopic shape can also be depth information predicted based on historical image data obtained by the display device or image data of the current environment obtained from other channels (such as the Internet), such as the stereoscopic shape corresponding to the mesh grid.

In one embodiment of the present disclosure, the preset stereoscopic shape is a sphere. Determining the first depth information of the preset stereoscopic shape comprises: determining a center of a sphere according to a position of the display device, and determining a corresponding sphere with a preset length as a radius; determining the first depth information based on a surface of the sphere. The preset length can be greater than or equal to 4 meters, for example, 5 meters.

In the embodiment of the present disclosure, the position of the display device may not be the position coordinates in the real world coordinate system, but may be a relative position determined based on sensing data, such as inertial sensing data. As long as the display device is located at the center of the sphere, the embodiment of the present disclosure does not limit the way to determine the position of the display device.
203. Determining a first VST result according to the first depth information and the first posture.

Specifically, the visual sensor (such as RGB camera) on the display device can collect the texture information of the environment where the display device is located, and then fuse the texture information on the mesh grid (such as the mesh grid determined on the surface of a sphere) based on the first posture) determined based on the first depth information.

As can be seen from the above depiction, According to the method for VST of the embodiments of the present disclosure, fixed depth information is obtained by constructing a preset stereoscopic shape, and then VST effect is realized based on the fixed depth information. As such, the VST effect can be realized under the condition that the depth information is not fully obtained or cannot be obtained, improving the smoothness of image display of a display device such as a headset and enhancing the user experience.

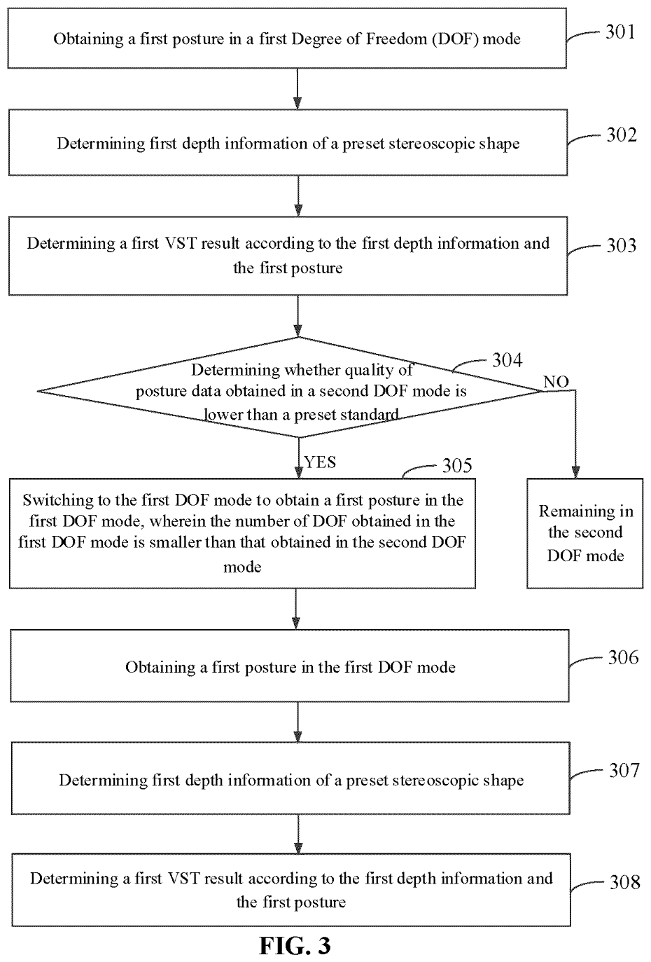

Referring to FIG. 3, FIG. 3 illustrates a flowchart II of a method for VST according to an embodiment of the present disclosure. In this embodiment, the implementation process and switching strategy of video see-through in different scenarios are described in detail. The method for VST comprises:
301. Obtaining a second posture in a second DOF mode.
302. Obtaining sensing data, and determine second depth information according to the sensing data.
303. Determining a second VST result according to the second posture and the second depth information.
304. Judging whether quality of posture data obtained in a second DOF mode is lower than a preset standard, if so, executing step 305, if not, continuing to maintain in a second DOF mode.

In one embodiment of the present disclosure, the display device comprises a color sensor, and obtaining the sensing data and determining the second depth information according to the sensing data comprises: obtaining first image data by the color sensor; determining second depth information according to the first image data.

Specifically, the second depth information can be determined only by the first image data obtained by a color sensor, such as an RGB camera.

In one embodiment of the present disclosure, the display device further comprises a depth sensor, and determining the second depth information according to the first image data comprises: in response to the depth sensor failing, determining the second depth information according to the first image data; in response to the depth sensor working normally, obtaining depth sensing data by a depth sensor, and determining the second depth information according to the depth sensing data and the first image data.

Specifically, when the display device is equipped with a depth sensor (such as a Time Of Flight (TOF) sensor), if the depth sensor can work normally, the second depth information can be determined by combining the depth sensing data obtained by the depth sensor and the first image data obtained by the color sensor. Compared with the above-mentioned method of determining the second depth information only based on the first image data obtained by the color sensor, such method has higher accuracy of depth information. Therefore, in the case of improving the accuracy for VST display, this method can be preferred. When the depth sensor fails to work normally, the second depth information is determined only based on the first image data obtained by the color sensor.
305. Switching to the first DOF mode to obtain a first posture in the first DOF mode, wherein the number of DOF obtained in the first DOF mode is smaller than that obtained in the second DOF mod.

In the embodiment of the present disclosure, when the second freedom mode is switched from to the first freedom mode, the adopted depth information is switched from the second depth information to the first depth information.

In an realizable way, when switching from the second depth information to the first depth information, taking the mesh grid as an example, the origin coordinate of the mesh grid would be switched from (0,0,0) in the world coordinate system to the position where the display device is located, that is, the center of the sphere.
306. Obtaining a first posture in the first DOF mode.
307. Determining first depth information of a preset stereoscopic shape.
308. Determining a first VST result according to the first depth information and the first posture.

Steps 306 to 308 in the embodiment of the present disclosure are similar to steps 201 to 203 in the above-mentioned embodiment, and will not be repeated here.

Illustratively, the method for VST provided by the embodiment of the present disclosure can cover the following scenarios:

The first scenario: when the depth information service (such as a TOF cannot work normally) is valid, VST is used normally.

The second scenario: when the depth information service (such as a TOF cannot work normally) is invalid, VST can still be used.

At this time, some depth information is missing, and the depth information collected through RGB is still synthesized into VST through 6 DOF, and the VST effect would be slightly worse.

In the second scenario, if the 6 DOF quality is lower than the preset standard, the second scenario is switched to the third scenario. Switching process: it can be instantaneous switching, or it can be completed within a preset time, such as 10 ms. The switching process can be set to instantaneous switching to quickly ensure the bottom experience, or it can be switched without moving the head.

The third scenario: In the 3 DOF state, VST can still be used. For example, when the ambient light is extremely bright/dark, the 6 DOF service is not available, and VST can be used under 3 DOF.

In this scenario, there is an obvious switching feeling upon switching. At this time, the depth for VST can be switched to the first depth information of a preset stereoscopic shape, such as the depth information determined by the surface of a 5 m sphere. Before switching to this state, the service state of 6 DOF may be unstable (the 6 DOF stays on the last result and cuts a fixed depth).

The trigger condition for switching back to the second scenario can be: 6 DOF signal recovery. Switching process can be set to have a delay, about 70-100 ms.

From the above description, it can be seen that the method for VST provided by the embodiment of the present disclosure can realize the VST display effect in different scenarios by adopting different depth information determination methods for different scenarios, so that different scenarios can switch processes, and the user experience is improved.

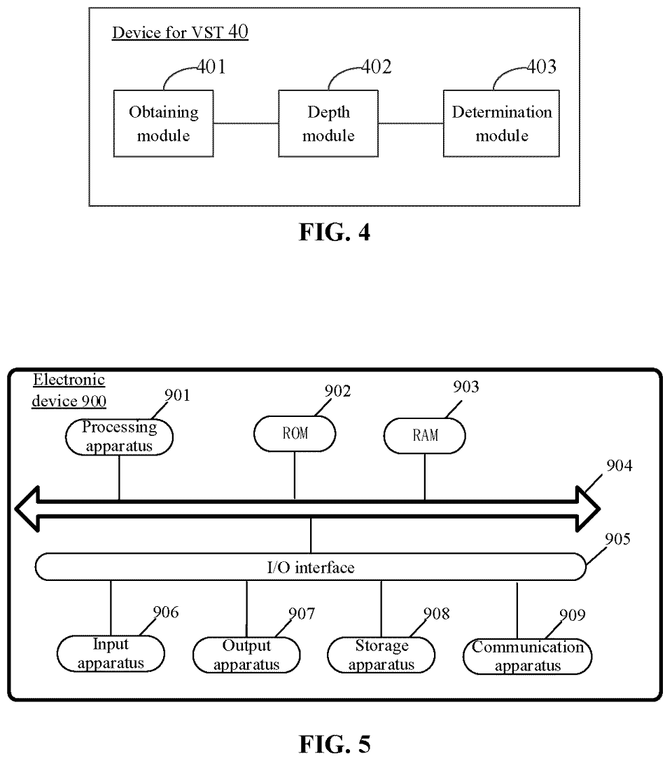

Corresponding to the method for VST of the above embodiment, FIG. 4 illustrates a structural block diagram of a device for VST according to an embodiment of the present disclosure. For convenience of explanation, only parts related to the embodiment of the present disclosure are shown. Referring to FIG. 4, the device comprises: an obtaining module 401, a depth module 402 and a determination module 403.

The obtaining module 401 is configured to obtain a first posture in a DFO mode.

The depth module 402 is configured to determine first depth information of a preset solid shape.

A determining module 403 is configured to determine a first VST result according to the first depth information and the first posture.

In one embodiment of the present disclosure, the preset stereoscopic shape is a sphere.

In one embodiment of the present disclosure, the depth module 402 is specifically used for:
determining a center of a sphere according to a position of the display device, and determining a corresponding sphere with a preset length as a radius;
determining the first depth information based on a surface of the sphere.

In one embodiment of the present disclosure, the obtaining module 401 is specifically used for:

In response to quality of posture data obtained in a second DOF mode being lower than a preset standard, switching to the first DOF mode to obtain a first posture in the first DOF mode, wherein the number of DOF obtained in the first DOF mode is smaller than that obtained in the second DOF mode.

In one embodiment of the present disclosure, the quality of posture data obtained in the second DOF mode being lower than the preset standard comprises meeting at least one of the following:
light intensity of current environment being less than a first intensity or greater than a second intensity, wherein the first intensity is smaller than the second intensity;
a jitter value of the display device is greater than a preset jitter threshold;
an error of sensor data of the display device is greater than a first preset error value;
an error of image data obtained by a camera of the display device is greater than a second preset error value.

In an embodiment of the present disclosure, the obtaining module 401 is further configured to:
obtain a second posture in a second DOF mode;
obtain sensing data, and determining second depth information according to the sensing data;
determine a second VST result according to the second posture and the second depth information.

In one embodiment of the present disclosure, the display device comprises a color sensor, and the obtaining module 401 is specifically configured to:
obtain first image data by the color sensor;
determine second depth information according to the first image data.

In an embodiment of the present disclosure, the display device further comprises a depth sensor, and the obtaining module 401 is specifically configured to:
in response to the depth sensor failing, determine the second depth information according to the first image data;
in response to the depth sensor working normally, obtain depth sensing data by a depth sensor, and determine the second depth information according to the depth sensing data and the first image data.

The device provided in this embodiment can be used to implement the subject matter of the above method embodiment, and its implementation principle and technical effect are similar, so the details of this embodiment are not repeated here.

In order to realize the above embodiment, the embodiment of the present disclosure also provides an electronic device.

Referring to FIG. 5, it shows a structural schematic diagram of an electronic device 900 suitable for implementing the embodiment of the present disclosure. The electronic device 900 may be a terminal device or a server. The terminal device may include, but is not limited to, mobile terminals such as mobile phones, notebook computers, digital broadcast receivers, Personal Digital Assistant (PDA), Tablet Computer, Portable Media Player (PMP), vehicle-mounted terminals (such as vehicle-mounted navigation terminals), and fixed terminals such as digital TVs and desktop computers. The electronic device shown in FIG. 5 is only an example, and should not bring any limitation to the function and application scope of the embodiment of the present disclosure.

As shown in FIG. 5, the electronic device 900 may include a processing apparatus (such as a central processing unit, a graphics processor, etc.) 901, which may perform various appropriate actions and processes according to a program stored in a Read Only Memory (ROM) 902 or a program loaded from a storage apparatus 908 into a Random Access Memory (RAM) 903. In the RAM 903, various programs and data required for the operation of the electronic device 900 are also stored. A processing apparatus 901, a ROM 902 and a RAM 903 are connected to each other through a bus 904. An input/output (I/O) interface 905 is also connected to the bus 904.

Generally, the following apparatus can be connected to the I/O interface 905: an input apparatus 906 comprising, for example, a touch screen, a touch pad, a keyboard, a mouse, a camera, a microphone, an accelerometer, a gyroscope, etc.; an output apparatus 907 comprising, for example, a Liquid Crystal Display (LCD), a speaker, a vibrator, etc.; a storage apparatus comprising, for example, a magnetic tape, a hard disk, etc.; a communication apparatus 909. The communication apparatus 909 may allow the electronic device 900 to communicate wirelessly or wired with other devices to exchange data. Although FIG. 5 shows the electronic device 900 with various apparatus, it should be understood that it is not required to implement or have all the apparatus shown. More or fewer apparatus may alternatively be implemented or provided.

In particular, according to an embodiment of the present disclosure, the process described above with reference to the flowchart can be implemented as a computer software program. For example, an embodiment of the present disclosure comprises a computer program product, which comprises a computer program carried on a computer-readable medium, and the computer program contains program code for executing the method shown in the flowchart. In such an embodiment, the computer program can be downloaded and installed from the network through the communication apparatus 909, or installed from the storage apparatus 908 or from the ROM 902. When the computer program is executed by the processing apparatus 901, the above functions defined in the method of the embodiment of the present disclosure are performed.

It should be noted that the computer-readable medium mentioned above in this disclosure can be a computer-readable signal medium or a computer-readable storage medium or any combination of the two. The computer-readable storage medium can be, for example, but not limited to, an electrical, magnetic, optical, electromagnetic, infrared, or semiconductor system, device or device, or a combination of any of the above. More specific examples of computer-readable storage media may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In this disclosure, a computer-readable storage medium can be any tangible medium containing or storing a program, which can be used by or in combination with an instruction execution system, apparatus or device. In this disclosure, a computer-readable signal medium may include a data signal propagated in baseband or as part of a carrier wave, in which computer-readable program codes are carried. This propagated data signal can take many forms, comprising but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program code contained in the computer-readable medium can be transmitted by any suitable medium, comprising but not limited to: wires, optical cables, RF (radio frequency) and the like, or any suitable combination of the above.

The computer-readable medium may be included in the electronic device; or it can exist alone without being assembled into the electronic device.

The computer-readable medium carries one or more programs, which, when executed by the electronic device, cause the electronic device to perform the method shown in the above embodiments.

Computer program codes for performing the operations of the present disclosure may be written in one or more programming languages or combinations thereof, comprising object-oriented programming languages such as Java, Smalltalk, C++, and conventional procedural programming languages such as “C” or similar programming languages. The program code can be completely executed on the user's computer, partially executed on the user's computer, executed as an independent software package, partially executed on the user's computer and partially executed on a remote computer, or completely executed on a remote computer or server. In the case of involving a remote computer, the remote computer can be connected to a user computer through any kind of network, comprising a Local Area Network (LAN) or a Wide Area Network (WAN), or can be connected to an external computer (for example, by using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiment described in the present disclosure can be realized by software or hardware. Among them, the name of the unit does not constitute the limitation of the unit itself in some cases. For example, the first obtaining unit can also be described as “the unit that obtains at least two Internet protocol addresses”.

The functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of this disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, device or equipment, or any suitable combination of the above. More specific examples of the machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

The above description is only the preferred embodiment of the present disclosure and the explanation of the applied technical principles. It should be understood by those skilled in the art that the disclosure scope involved in this disclosure is not limited to the subject matter formed by the specific combination of the above technical features, but also covers other subject matters formed by any combination of the above technical features or their equivalent features without departing from the above disclosure concept. For example, the above features are replaced with (but not limited to) technical features with similar functions disclosed in this disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

I/We claim:

1. A method for Video See-Through (VST) applied to a display device, comprising:
obtaining a first posture in a first Degree of Freedom (DOF) mode;
determining first depth information of a preset stereoscopic shape; and
determining a first VST result according to the first depth information and the first posture.

2. The method according to claim 1, wherein the preset stereoscopic shape is a sphere.

3. The method according to claim 2, wherein determining the first depth information of the preset stereoscopic shape comprises:
determining a center of a sphere according to a position of the display device, and determining a corresponding sphere with a preset length as a radius; and
determining the first depth information based on a surface of the sphere.

4. The method according to claim 1, wherein obtaining the first posture in the DOF mode comprises:
in response to quality of posture data obtained in a second DOF mode being lower than a preset standard, switching to the first DOF mode to obtain a first posture in the first DOF mode, wherein the number of DOF obtained in the first DOF mode is smaller than that obtained in the second DOF mode.

5. The method according to claim 4, wherein the quality of posture data obtained in the second DOF mode being lower than the preset standard comprises meeting at least one of the following:
light intensity of current environment being less than a first intensity or greater than a second intensity, wherein the first intensity is smaller than the second intensity;
a jitter value of the display device being greater than a preset jitter threshold;
an error of sensor data of the display device being greater than a first preset error value; and
an error of image data obtained by a camera of the display device being greater than a second preset error value.

6. The method according to claim 1, wherein before obtaining the first posture in the first DOF mode, the method further comprises:
obtaining a second posture in the second DOF mode;
obtaining sensing data, and determining second depth information according to the sensing data; and
determining a second VST result according to the second posture and the second depth information.

7. The method according to claim 6, wherein the display device comprises a color sensor, and obtaining the sensing data and determining the second depth information according to the sensing data comprises:
obtaining first image data by the color sensor; and
determining the second depth information according to the first image data.

8. The method according to claim 7, wherein the display device further comprises a depth sensor, and determining the second depth information according to the first image data comprises:
in response to the depth sensor failing, determining the second depth information according to the first image data; and
in response to the depth sensor working normally, obtaining depth sensing data by a depth sensor, and determining the second depth information according to the depth sensing data and the first image data.

9. An electronic device comprising: a processor and a memory, wherein:
the memory stores computer-executed instructions; and
the processor executes the computer-executed instructions stored in the memory such that the processor executes a method for VST comprising:
obtaining a first posture in a first Degree of Freedom (DOF) mode;
determining first depth information of a preset stereoscopic shape; and
determining a first VST result according to the first depth information and the first posture.

10. The electronic device according to claim 9, wherein the preset stereoscopic shape is a sphere.

11. The electronic device according to claim 10, wherein determining the first depth information of the preset stereoscopic shape comprises:
determining a center of a sphere according to a position of the display device, and determining a corresponding sphere with a preset length as a radius; and
determining the first depth information based on a surface of the sphere.

12. The electronic device according to claim 9, wherein obtaining the first posture in the DOF mode comprises:
in response to quality of posture data obtained in a second DOF mode being lower than a preset standard, switching to the first DOF mode to obtain a first posture in the first DOF mode, wherein the number of DOF obtained in the first DOF mode is smaller than that obtained in the second DOF mode.

13. The electronic device according to claim 12, wherein the quality of posture data obtained in the second DOF mode being lower than the preset standard comprises meeting at least one of the following:
light intensity of current environment being less than a first intensity or greater than a second intensity, wherein the first intensity is smaller than the second intensity;
a jitter value of the display device being greater than a preset jitter threshold;
an error of sensor data of the display device being greater than a first preset error value; and
an error of image data obtained by a camera of the display device being greater than a second preset error value.

14. The electronic device according to claim 1, wherein before obtaining the first posture in the first DOF mode, the method further comprises:
obtaining a second posture in the second DOF mode;
obtaining sensing data, and determining second depth information according to the sensing data; and
determining a second VST result according to the second posture and the second depth information.

15. The electronic device according to claim 14, wherein the display device comprises a color sensor, and obtaining the sensing data and determining the second depth information according to the sensing data comprises:
obtaining first image data by the color sensor; and
determining the second depth information according to the first image data.

16. The electronic device according to claim 15, wherein the display device further comprises a depth sensor, and determining the second depth information according to the first image data comprises:
in response to the depth sensor failing, determining the second depth information according to the first image data; and
in response to the depth sensor working normally, obtaining depth sensing data by a depth sensor, and determining the second depth information according to the depth sensing data and the first image data.

17. A non-transitory computer-readable storage medium, wherein the computer-readable storage medium stores computer-executable instructions therein, and a processor, when executing the computer-executable instructions, implements a method for VST comprising:
obtaining a first posture in a first Degree of Freedom (DOF) mode;
determining first depth information of a preset stereoscopic shape; and
determining a first VST result according to the first depth information and the first posture.

18. The non-transitory computer-readable storage medium according to claim 17, wherein the preset stereoscopic shape is a sphere.

19. The non-transitory computer-readable storage medium according to claim 18, wherein determining the first depth information of the preset stereoscopic shape comprises:
determining a center of a sphere according to a position of the display device, and determining a corresponding sphere with a preset length as a radius; and
determining the first depth information based on a surface of the sphere.

20. The non-transitory computer-readable storage medium according to claim 17, wherein obtaining the first posture in the DOF mode comprises:
in response to quality of posture data obtained in a second DOF mode being lower than a preset standard, switching to the first DOF mode to obtain a first posture in the first DOF mode, wherein the number of DOF obtained in the first DOF mode is smaller than that obtained in the second DOF mode.
